(19) United States
(12) Patent Application Publication
(10) Pub. No.: US 2011/0218894 A1
(43) Pub. Date: Sep. 8, 2011

(54) Variable Taxation System and Method

(76) Inventor: Walter T. Perkins, South Riding, VA (US)

(21) Appl. No.: 12/715,416

(22) Filed: Mar. 2, 2010

(51) Int. Cl. G06Q 40/00; G06Q 10/00; G06Q 50/00; G06Q 30/00; G06F 7/00

(52) U.S. Cl. 705/31; 705/412; 705/34; 707/802; 707/E17.044

(57) ABSTRACT

A variable taxation/variable goods control system includes a consumer database populated with a plurality of consumers, a goods database populated with one or more goods limits for a predetermined time period, and a tax rate database populated with at least a first tax rate and a second tax rate. Each of the plurality of consumers in the consumer database is affiliated with at least a first goods limit in the energy database. Each consumer in the consumer database is affiliated with at least the first tax rate in the tax rate database, the first tax rate corresponding to the first goods limit. Each consumer is taxed at the first tax rate for goods purchases up to the consumer's first goods limit, and each consumer is taxed at the second or higher tax rate for goods purchases beyond the first goods limit.

### BACKGROUND OF THE INVENTION

1. Field of the Invention

The present invention relates to taxation systems, and more particularly to an automated variable taxation system and method for the application of taxes, such as excise taxes.

2. Prior Art

Almost every person makes daily decisions regarding purchases of food, housing, transportation, energy consumption, and numerous other goods and commodities. For the most part, there are few legal limits on such purchases. If you can pay for it, you can buy it.

This is even true of items on which the government has made a policy decision of taxing to discourage consumption. Except for quantity discounts or similar “free market” factors to reduce the price, the per-unit price for purchasing one or a hundred pieces or units is the same as when purchasing a few. Taxation per each piece or unit is the same for all. It is to be noted that numerous utilities impose price increases based on the volume of usage or consumption in a certain time period and several other similar criteria which may even be applied in a matrix to set charges. This is not a tax per se, but rather a device to level demand so as to optimize production capacity and avoid potentially higher unit costs, in that the demand that is targeted for reduction may require differing production methods or the purchase of product from outside sources, in addition to limiting demand so as to avoid potential system overload and system failure.

The regressive nature of excise taxes, or “sin taxes” has long been a problem. History shows that the inequitable nature of the taxes was an issue since the beginnings of our Republic. To this day, a flat tax per unit of product is used by governmental agencies, even for such commonly consumed items as gasoline, tobacco and alcohol, usually with an apportionment for fractions of the base unit. It is a sheer ‘one price’ system.

The ‘one price’ system has a hidden characteristic. Namely, the government needs to keep such taxes comparatively low to insure that poorer citizens can buy a reasonable quantity of the goods. This practice makes the taxed goods available to more of the population, but likely reduces the overall tax revenue in addition to failing to impede the demand of profligate consumers with an ability to spend more for the goods.

This characteristic may also be perceived as a structural unfairness. Rich or poor pay the same amount per piece or unit, e.g., per gallon of gasoline, pack of cigarettes, bottle of whiskey, or kilowatt hour. There is no tax reduction or abatement or other condition, except for a small possibility for an income tax deduction that would move the tax toward progressive or equitable standards. In addition to the poor or low income consumers, businesses with narrow profit margins but a need for one of the subject goods, are also penalized disproportionately by the present system.

There is a need for an improved taxation system.

### SUMMARY OF THE INVENTION

It is an object of the invention to provide a variable taxation system and method that provides the flexibility to increase the per unit tax and possibly impose other consumption controls to accomplish a variety of results which are presently far beyond the ability of the present tax system.

It is a further object of the invention to provide a taxation system which avoids the problems associated with outright bans on particular products. For the purposes of this invention, goods, services, products and commodities, to include gasoline, tobacco, alcohol, electricity and other energy sources, which may be subject to taxation are generally described as goods. In addition, the term variable taxation also includes the concept of product or goods quantity control.

It is a further object of the invention to provide a taxation system that provides for the possibility to adjust different tax rates for defined geographic areas. For example, consumers in a defined locality could pay more fuel tax for the repair of a bridge, thereby obviating the need for a toll arrangement. Or they could pay to reduce smog or dangerous intersections.

It is an objective of the taxation system and method to control and manage the taxes on particular goods, e.g., vehicle fuel, to achieve numerous benefits.

It is yet a further objective to provide a taxation system that would modify consumer behavior to enable a decrease of greenhouse gases and a substantial reduction in the contribution of internal combustion engines to air pollution.

It is a further object of the invention to increase tax revenue in a fair and equitable manner.

In a first aspect of the present invention, a variable taxation system is proposed, comprising

a consumer database populated with a plurality of consumers;

a goods, e.g., fuel/energy/commodity, database (or map) populated with one or more goods limits (or categories) for a predetermined time period; and

a tax rate database populated with at least a first tax rate and a second tax rate,

wherein each of the plurality of consumers in the consumer database is affiliated with at least a first goods limit in the goods database,

wherein each consumer in the consumer database is affiliated with at least the first tax rate in the tax rate database, the first tax rate corresponding to the first goods limit,

wherein each consumer is taxed at the first tax rate for goods purchases up to the consumer's first goods limit,

wherein each consumer is taxed at the second tax rate for goods purchases beyond the first goods limit.

In a first embodiment, the variable taxation system further includes a consumer identification device corresponding to each consumer to identify each consumer. This provides an easy, portable way for a person to control access to his account, to include his goods at the first tax rate and the second and any other subsequent tax rate.

The fuel/energy/commodity database (or interactive connection) may allow the imposition of various tax rates or volume limits based upon the identification of individual consumers or groups of consumers wishing to make purchases.

The tax rate database is populated with criteria to associate with consumers for the imposition of at least two tax differing rates and/or volume limits on purchases.

In a first embodiment, the variable taxation system further includes a consumer identification. This may be simply part of the consumer account for billing. Or, for point of sale purchases, such as gasoline, it can be a device corresponding to each consumer or part of a consumer payment mechanism, such as a credit card, debit account, etc.

The consumer identification item may include a wide variety of known devices, including smart cards, RFID tags, credit cards, identification cards and biometric input devices. A single type of device may be mandated to standardize systems throughout the predetermined geographic area, or alternatively, a person may choose a device that is preferred for his own purposes, or that offers more flexibility with his existing identification cards, credit cards and computer systems.

In another embodiment, where a single consumer has multiple identification devices, the multiple identification devices corresponding to a single consumer are identified and linked in the consumer identity found in the system, e.g., the consumer database. The cancellation, loss or destruction of a consumer's device would not have any effect on the status of the consumer's account. The data corresponding to a consumer would not be stored in the identification device, but would be at a remote, secure location to prevent tampering, and to negate reliability issues from damage identification devices, to include those intentionally tampered with.

In a second aspect of the invention a method of operating a variable taxation system having a consumer database, a goods database, and a tax rate database, comprises the steps of:
determining one or more tax rates and/or volume purchase limits to populate the tax rate database;
populating a consumer database with a plurality of consumers;
affiliating each of the plurality of consumers in the consumer database with at least a first goods limit in the goods database;
affiliating each consumers in the consumer database with at least a first tax rate or charge and a second tax rate in the tax rate database, the first tax rate corresponding to the first goods limit,

wherein each consumer is taxed at the first tax rate for goods purchases up to the consumer's first goods limit,

wherein each consumer is taxed at the second tax rate for goods purchases beyond the first goods limit.

In one embodiment, the first goods limit may include no numbered limit. That is, the first goods limit may be unlimited.

In one embodiment, the method of operating the variable taxation system further includes
identifying each consumer with an identification device corresponding to each consumer. A unique identifier and identification device for each consumer has the advantage of deconflicting the variable taxation system and method from other identification systems, and permits a smaller, less burdened governmental agency to operate it, with a relatively small staff. In addition, this reduces the amount of damage an identity thief can do if only one of a consumer's identification numbers is compromised.

In another embodiment, the method of operating the variable taxation system further includes
identifying and linking, in the consumer database, any identification devices that correspond to a single consumer. This arrangement assists in the prevention of fraud, as a consumer cannot provide his benefits to another person without being charged for it. Also, if the consumer has two or more different identification devices, the use of one will be assessed to all of the consumer's devices.

In additional embodiments, other antifraud measures include the anti-jumping meter devices and programs now used by public utilities, the real-time photo and video cameras now used at toll booths to record the license numbers and vehicle types at gas pumps, a computer program to check ownership and title records of vehicles. In addition, the system could compare the reported state vehicle inspection mileage against the gasoline purchases made by tax-favored consumers and may place a volume limit on those tax-favored categories or individuals. If all or any part of the tax determinations and therefore adjustments are predicated on income, socially desirable activities, business operations or similar factors, differing and appropriate review or audit procedures and verifications can be utilized.

In a further embodiment, the method of operating the variable taxation system may further include
determining and maintaining a remaining goods balance in the goods database for each consumer and each tax rate. This provides the advantage that each of a consumer's goods purchases will be assessed against his volume limit.

In yet another embodiment, the method of operating the variable taxation system may further include
selectively permitting and preventing a remaining balance from one consumer to another consumer. This provides another way to prevent fraud upon the taxation authorities. Under certain conditions, a consumer may be permitted to allow another to purchase goods in his name, such as if handicapped, or for a business. In most cases, a consumer would be unable to access the account of another consumer. There would also be a mechanism for an individual to replace vehicles, change homes or business locations or similar modifications.

The method of operating the variable taxation system may further include
rolling over the remaining goods balance for a consumer into a new predetermined time period. This provides an advantage for a consumer who was unable to access the system near the end of a predetermined time period, in that he will not incur a penalty for lack of access. However, such rollover conditions may be limited to a predetermined number of time periods to prevent a consumer from stockpiling or hoarding his goods, particularly at the lowest tax rate.

The method of operating the variable taxation system may further include
rolling over the remaining balance for a consumer, up to a predetermined limit, into a new predetermined time period. The consumer may be prevented from stockpiling or hoarding his access to goods, particularly at the lowest tax rate. This encourages the consumer to plan ahead and to think about the consequences of his purchases.

In a further embodiment, the method of operating the variable taxation system further includes
maintaining, in the tax rate database, a different tax rate for each different type of goods subject to the system. The term “goods” may include any type of product or service available in the marketplace, e.g., fuel, energy, tobacco, alcohol, etc. Each may have a unique limit at a lowest tax rate, and the tax rates may be unique for each of the goods, and for each tax category of the goods as well. This provides the advantage that the government may be extremely selective in its encourage or discouragement of particular purchases and associated behaviors.

In yet another embodiment, the method of operating the variable taxation system further includes
maintaining, in the tax rate database, a plurality of different tax rates corresponding to predetermined characteristics of each of the plurality of consumers. This provides another way for a government to very selectively encourage or discourage particular purchases and associated behavior.

In a further embodiment of the method of operating the variable taxation system, the predetermined characteristics of each of the plurality of consumers may include at least one of the following and other criteria:
a consumer income level, a commercial use status, a personal use status, a pleasure/recreation use status, a handicapped use status, and a charitable use status.

Additional characteristics may include age, sex, income, income savings rate, real property ownership, automobile ownership, healthcare needs, education, type of employment, and other characteristics. These characteristics provide additional opportunities for a government to encourage or discourage particular purchases and behaviors.

The method of operating the variable taxation system may further include
applying a default tax rate for purchases made without a consumer identification, wherein the second tax rate is higher than the first tax rate.

This provides the advantage that a consumer who has misplaced his identification can still make purchases. The second tax rate may actually be a substantial increase to prevent the circumventing of volume limits of the basic program.

In another embodiment, the method of operating the variable taxation system further comprises
applying a default (high) tax rate for purchases made without a remaining goods balance, wherein the default tax rate is higher than the first tax rate. This provides the advantage that a consumer who has misplaced his identification can still make purchases. The default tax rate may be a second, third, fourth or higher rate to encourage proper control of a consumer's identification devices, and to encourage the use of foresight in the consumption of the goods.

In a further embodiment, the method of operating the variable taxation system further comprises
communicating, at the time of purchase, the consumer identification and a desired fuel/energy/commodity; and
determining a correct tax rate based on the consumer identification and the fuel/energy/commodity desired for purchase. The instant communication, via computer networks, provides the advantage that a consumer will always have access to his correct goods balance, not matter how frequently, or how much, he purchases. Communications networks make it possible to instantaneously determine exactly how much of a particular type of goods is available at a particular tax rate, so that a consumer should never be taxed inappropriately, and refunds should never be necessary.

In yet another embodiment, the method of operating the variable taxation system includes
encrypting all communications and consumer records. The identity of a consumer, and the amount of goods available to him at a particular tax rate, are very personal and should be protected at every level. Encryption prevents the unauthorized access, and use, of another's account information and encourages confidence in the system.

The system has the potential for adjusting the taxes, e.g., excise taxes, collected by all levels of government. The two main types, well known to laymen, are the federal and state tax programs. There are also local and municipal levies. The system and method could easily allow for a continuation of the fixed tax presently comprising these programs or to create an independency of formulation of each tax according to the programs and criteria set by the appropriate taxing authorities in the different levels of government. It could also effectuate a relationship between two or more levels of government such that the tax imposed could be increased or decreased by any government in a manner consistent with the increases made by another or in a divergent or possibly oppositional direction. The method would allow unprecedented speed in tax policy implementation and impact, and would allow the possibility for a defined focus in economic intervention never before seen.

The consumer identification database is designed to most effectively and efficiently allow purchases while reducing fraud and system errors. It would also be subject to the plans and goals of the levels of government which impose tax. Without a national system, or a state-granted card to other persons or entities, visitors to a state or purchasers outside their state or region may pay the default tax rate. As an alternative, a state could lower the default tax rate to encourage purchases of particular items or maintain a low default tax rate on such items as gasoline to encourage tourism or similar objectives. There are also numerous possibilities for a national consumer identification card with limits on information or access to assuage fears of misuse of the associated information. The implementation of fewer categories and criteria for differing tax rates would minimize the collection, collation and analysis of information for the method.

The development and utilization of purchase limits or an inventory database could also reflect the reality of the levels of government imposing taxes, e.g., excise taxes. This may be reflected in the system through the use of inventory reports for meeting targeted levels of consumption to conserve resources or to reduce and possibly eliminate purchase limits, or even a tax to aid certain areas or regions, such as those suffering from a natural disaster.

This application relates to a system and method wherein selected consumer characteristics may be considered in determining the amount of excise taxes to be charged on several items, most prominently vehicle fuel.

These and other aspects of the invention will be apparent from and further explained with reference to the embodiments described hereinafter.

### BRIEF DESCRIPTION OF THE DRAWINGS

FIG. 1 illustrates a diagram of a variable taxation system, in accordance with an embodiment of the invention;

FIG. 2 illustrates a diagram of a variable taxation system, according to an embodiment of the invention;

FIG. 3 illustrates a diagram of a consumer database for a variable taxation system, according to an embodiment of the invention;

FIG. 4 illustrates a diagram of a goods database for a variable taxation system, according to an embodiment of the invention;

FIG. 5 illustrates a diagram of a tax rate database for a variable taxation system, according to an embodiment of the invention; and

FIG. 6 illustrates a method of operating a variable taxation system, according to an embodiment of the invention.

### DETAILED DESCRIPTION OF THE INVENTION

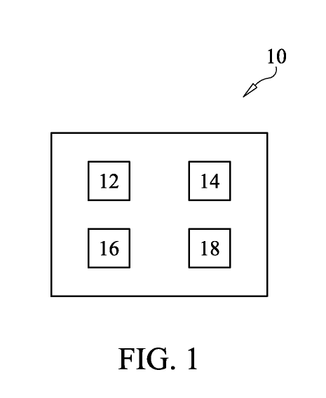

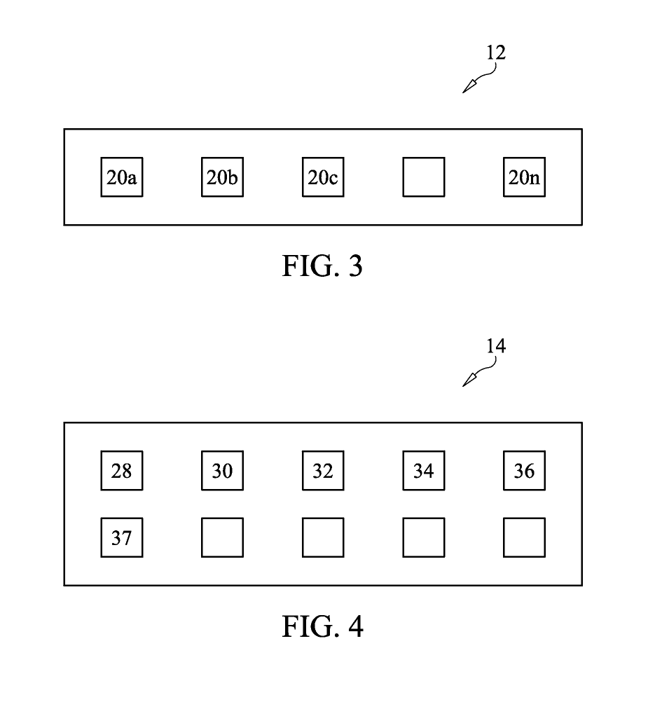

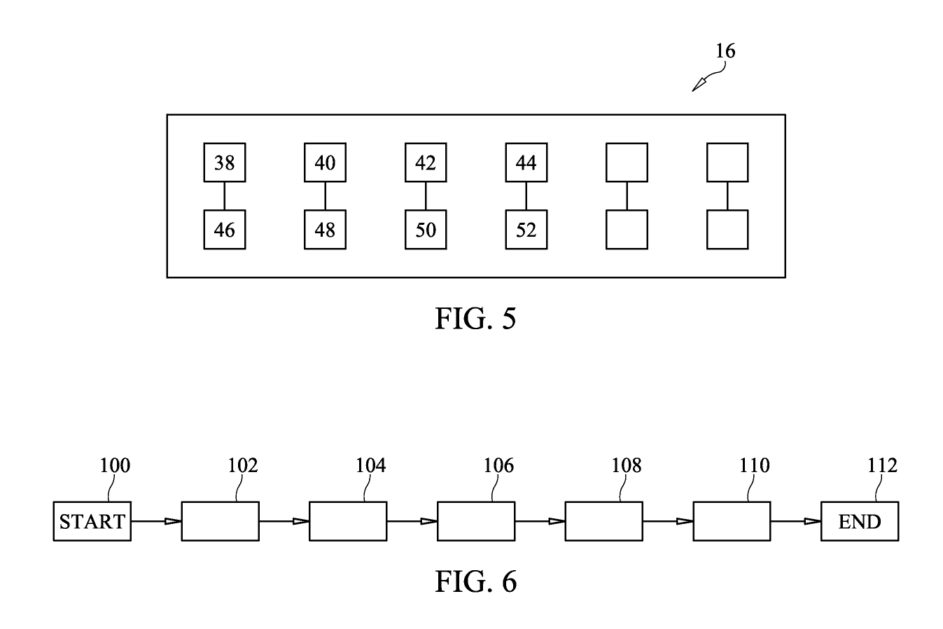

FIG. 1 illustrates a diagram of a variable taxation/variable product control system 10 comprising a consumer database 12, a goods database 14 and a tax rate database 16. The consumer database 12 (FIG. 3) is populated with a plurality of consumers 20 (20a-20n). The goods database 14 (FIG. 4), which may include, e.g., fuel, energy, tobacco, alcohol, marijuana, certain pharmaceuticals, or a variety of commodities, is populated with one or more goods categories for one or more predetermined time periods; and the tax rate database 16 (FIG. 5) is populated with at least a first tax rate 38 corresponding to a first predetermined goods limit 46 and a second tax rate 40 corresponding to a second predetermined goods limit 48.

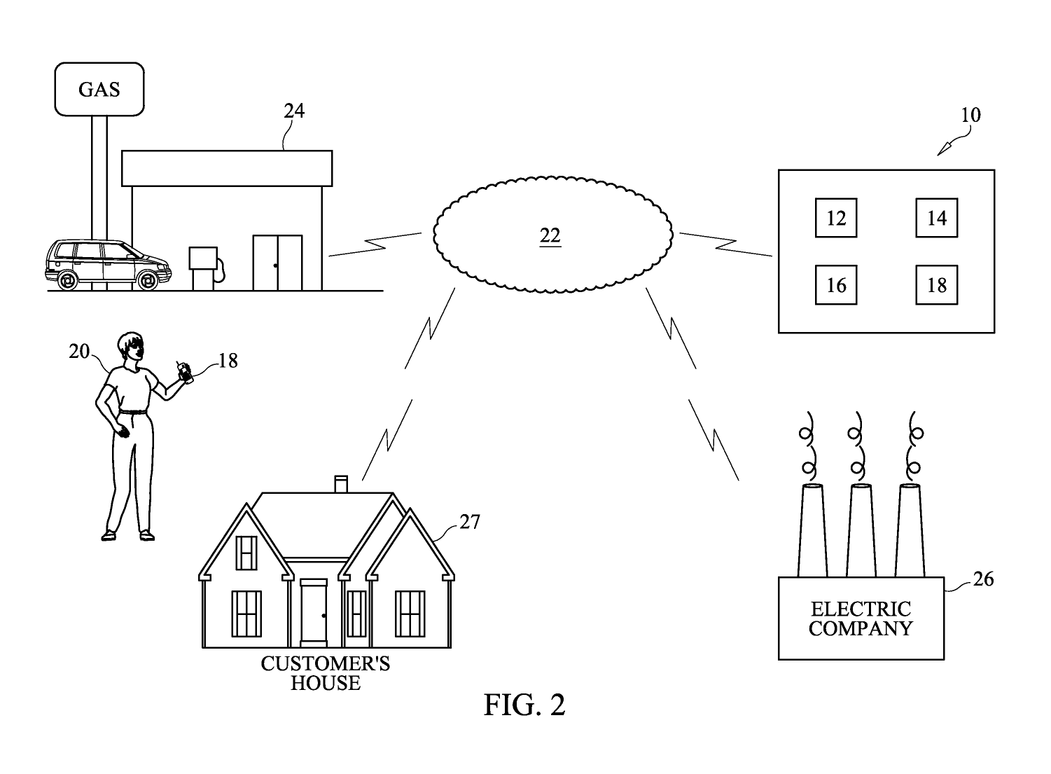

FIG. 2 is an overall diagram of a sale interaction using the system. In the example, 24 is the point of sale, which in this example is a gasoline service station, but could be numerous other types of retailers or places where the appropriate system mechanisms are available. The method according to the present invention is described in detail below, with the description of FIG. 6.

Each of the plurality of consumers 20 in the consumer database 12 is affiliated with at least a first goods limit 46 in the goods database 14 or in the tax rate database 16, as desired. In this context, being “affiliated with” includes being identified for purposes of the system for tax change or specific volume limits, or both. Each consumer 20 in the consumer database 12 is affiliated with at least the first tax rate 38 in the tax rate database 16, wherein the first tax rate 38 corresponds to the first goods limit 46. Each consumer 20 is taxed at the first tax rate 38 for goods purchases up to the consumer's first goods limit 46, and each consumer 20 is taxed at the second tax rate 40 for goods purchases beyond the first goods limit 46 and corresponding to a second predetermined goods limit 48. Additional goods limits 50, 52, which may correspond to additional tax rates 42, 44 may be included as desired by the taxing authority. Of course, as a practical matter, if the first goods limit 46 is high enough, or unlimited, for everyone or for a group of consumers having one or more predetermined characteristics, then the second tax rate 40 would never be implemented.

FIG. 3 illustrates the consumer database 12, which may include a plurality of consumers 20a-20n. In application, it would be expected that many thousands of consumers would be included in the consumer database 12.

FIG. 4 illustrates a goods database 14. The term “goods” includes virtually everything that may be bought and sold, to include, but not limited to motor fuels 28, home heating fuel 30, business-oriented fuel 32, tobacco products 34, alcohol 36, electricity 37, and many more dozens of goods and services, as deemed appropriate by the taxing authorities.

The variable taxation/variable product control system may further include a consumer identification device 18 (see FIG. 2) corresponding to each consumer 20 to identify each consumer 20 in the system 10. The consumer identification device 18 may include a number of devices known in the art, e.g., smart cards, RFID tags, credit cards, biometric input devices, etc. . . . . Multiple identification devices 18 corresponding to a single consumer 20 may be identified and linked in the consumer database 12 to positively associate them with a common consumer.

FIG. 6 illustrates a method of operating a variable taxation system 10 having a consumer database 12, a goods database 14, and a tax rate database 16. The method starts 100 and continues with the steps of:
determining 102 one or more tax rates 38, 40, 42, 44 to populate the tax rate database 16;
determining 104 one or more goods limits 46, 48, 50, 52 for a predetermined time period to populate the goods database 14;
populating 106 a consumer database 12 with a plurality of consumers 20a-20n;
affiliating 108 each of the plurality of consumers 20 in the consumer database 12 with at least a first goods limit 46 in the goods database 14; and
affiliating 110 each consumer 20 in the consumer database 12 with at least a first tax rate 38 and a second tax rate 40 in the tax rate database 16, the first tax rate 38 corresponding to the first goods limit 46.

Each consumer 20 is taxed at the first tax rate 38 for goods purchases up to the consumer's first goods limit 46. Each consumer 20 may be taxed at the second tax rate 40 for goods purchases beyond the first goods limit 46, up to the second goods limit 48, as applicable. Thus ends 112 the method of operating the variable taxation system 10.

In one embodiment, the method of operating the variable taxation system 10 further includes identifying each consumer 20 with a consumer identification device 18. The consumer identification device 18 provides a unique identifier for a consumer 20. The identification device(s) 18 corresponding to each consumer 20 may be identified and linked in the consumer database 12.

In another embodiment, the method of operating the variable taxation system 10 further includes determining and maintaining a remaining goods balance in the goods database 14 for each consumer 20 and each tax rate 38, 40, 42, 44. The remaining goods balance represents the unused portion of the first goods limit 46 or subsequent goods limits 48, 50, 52.

According to another embodiment, the system 10 and method may selectively permit and/or prevent a transfer of the remaining balance from one consumer to another consumer, according to rules or limits imposed by the taxing authority. Any transfer may be limited as to the amount of goods as well. The system 10 may permit a consumer 20 to roll-over his remaining balance into a new predetermined time period. Additionally, the system 10 may permit a consumer 20 to roll-over the remaining balance into a new predetermined time period, but only up to a further predetermined limit. Unused goods, e.g., remaining balances, may be prevented from being rolled-over and accumulated indefinitely.

According to a further embodiment, the variable taxation system 10 and method may maintain, in the tax rate database 16, a different tax rate for each different type of goods. As illustrated in FIG. 5, the tax rate database 16 may include a first tax rate 38, a second tax rate 40, a third tax rate 42, a fourth tax rate 44, and as many additional tax rates as deemed necessary by the taxing authority. Similarly, the tax rate database 16 may include a first goods limit 46 corresponding to the first tax rate 38, a second goods limit 48 corresponding to the second tax rate 40, a third goods limit 50 corresponding to the third tax rate 42, a fourth goods limit 52 corresponding to the fourth tax rate 44, and as many additional goods limits as tax rates, or as deemed necessary by the taxing authority.

Additionally, the variable taxation/variable product control system 10 and method may include maintaining, in the tax rate database 16, a plurality of different tax rates corresponding to a plurality of predetermined characteristics of each of the plurality of consumers 20. Such predetermined consumer characteristics, which may be included in the consumer database 12 or other location, as desired, may include, a consumer income level, a type of automobile driven or owned, a commercial use status for one or more products or types of goods, a personal use status, a pleasure/recreation use status, a handicapped or medical use status, and a charitable use status. Of course, a number of additional demographic factors may be included to distinguish consumers from each other and to determine their individual taxation levels. In this manner, the taxing authority may define a first class of consumers and provide a first, e.g. low, excise tax rate, but with no volume limit. Thus, the consumer's profile would be used to determine whether or which tax rate is imposed.

The method of operating the variable taxation system 10 may further include the step of applying a default, e.g., high, tax rate for purchases made without a valid consumer identification, wherein the default tax rate would typically be higher than the first tax rate, or higher than the tax rate that would have been applied with a valid identification. The default tax rate may be established as the highest tax rate in the system in order to discourage purchases made without identification. This promotes responsible behavior in the consumers and more easily permits the taxing authority to track individual consumption. A consumer 20 would need to pay a higher tax rate in order to remain anonymous. Along the same lines, the method of operating the variable taxation system 10 may include the step of applying a default, e.g., high, tax rate for purchases made without a remaining goods balance, wherein the default tax rate is higher than the first tax rate, or the tax rate that would have been applied with a remaining goods balance.

The method of operating the variable taxation system 10 may further include the steps of communicating, at the time of purchase, the consumer identification and the identity of the goods that are desired; and determining a correct tax rate based on the consumer identification and the goods desired for purchase. Further, all communications may be encrypted via processes which are known in the art. FIG. 2 illustrates the purchase of motor fuel, e.g., gasoline or diesel, by a consumer 20 having a valid consumer identification device 18. Either before or after pumping the fuel, or taking delivery of or consuming other goods, the consumer 20 would present his identification device 18. The identification device 18, e.g., smart card, biometric device, credit card, driver license, etc. . . . , is linked to a variable taxation system 10, as described above. Based on the consumer's unique identification and associated tax rates for each of a plurality of goods, the system 10 will compute his remaining goods balance for the corresponding category, i.e., fuel in this example, and will determine the tax rate associated with the goods accordingly. The consumer 20 will be presented with a price based on the determined tax rate. The process is as fluid and seamless as a typical credit or debit card transaction, and the variable taxation method may be incorporated directly into credit, debit or other electronic payment systems. The consumer's identification device may be incorporated into a credit card, debit card or bank card to take advantage of existing operating and security systems. Thus, the system 10 would have little effect on the daily routines and lives of the consumers 20, except for the monetary significance of the tax rates.

As a further embodiment, the system 10 may be used at the household 27 or business level. The consumer's identification device 18 is associated with a house 27, apartment or business address for billing through a utility company, 26, such as an electric power company. The consumer's tax on his electric bill, for example may be determined, at least in part, on the amount of electricity consumed during a predetermined time period. For the purposes of the entire application, and not just this example, a predetermined time period may include a calendar-based time period, e.g., day, week, month, quarter, and/or time-of-day determinations.

As presented, the system 10 makes it possible to achieve numerous social policy goals by adjusting the costs, or even the availability, of motor fuel and numerous other goods by varying the tax burden. The disclosed variable taxation system would modify consumer behavior to enable a decrease of greenhouse gases and would lead to a substantial reduction in the contribution of internal combustion engines to air pollution, particularly in ‘smog’ areas.

The system 10 may be thought of not only as a variable taxation system, but a variable product control system in that governmental policy-makers may use this system 10 to encourage or discourage the use or consumption of particular goods and/or services. This power enables policy-makers to utilize the system 10 to achieve both long-term and short-term goals related to social policies.

The variable taxation/variable product control system 10 features the ability to change the cost of vehicle fuel and lead to the reduction of petroleum consumption despite the inelasticity of demand for it. This condition would reduce dependence on foreign oil and reduce the environmental risks attendant to domestic production. In addition to all of the benefits above, the implementation of these methods could actually save lives. A minor addition to the program could be made to reduce or stop the sale of fuel to chronic traffic offenders such as drunk drivers. The lives saved by this feature alone would justify the implementation of the methods and system worldwide. Finally, there are other applications and advantages in the methods and system that will become feasible as the idea is implemented. These are unique to certain areas, needs or customs but are anticipated by the general descriptions above.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effectuated by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A variable taxation system comprising:
a customer database populated with a plurality of customers;
a goods database populated with one or more goods limits for a predetermined time period;
a customer identification device corresponding to each customer to identify each customer, wherein the customer identification device is one of a credit card, a debit card and a driver license; and
a tax rate database populated with at least a first tax rate and a second tax rate,
wherein each of the plurality of customers in the customer database is affiliated with at least a first goods limit in the goods database,
wherein each customer in the customer database is affiliated with at least the first tax rate in the tax rate database, the first tax rate corresponding to the first goods limit,
wherein each customer is taxed at the first tax rate for goods purchases up to the customer's first goods limit,
wherein each customer is taxed at the second tax rate for goods purchases beyond the first goods limit,
wherein a remaining goods balance is determined and maintained in the goods database for each customer and each tax rate.

2. (canceled)

3. The variable taxation/variable product control system of claim 1, wherein the customer identification device includes at least one of a smart card, an RFID tag and a biometric input device.

4. The variable taxation/variable product control system of claim 1, wherein multiple identification devices corresponding to a single customer are identified and linked in the customer database.

5. A method of operating a variable taxation system having a customer database, a goods database, and a tax rate database, the method comprising the steps of:
determining one or more tax rates to populate the tax rate database;
determining one or more goods limits per a predetermined time period to populate the goods database;
populating a customer database with a plurality of customers;
affiliating each of the plurality of customers in the customer database with at least a first goods limit in the goods database;
identifying each customer with a customer identification device having a unique identifier, the identification device comprising one of a credit card, a debit card and a driver license;
affiliating each customer in the customer database with at least a first tax rate and a second tax rate in the tax rate database, the first tax rate corresponding to the first goods limit;
determining and maintaining a remaining goods balance in the goods database for each customer and each tax rate,
wherein each customer is taxed at the first tax rate for goods purchases up to the customer's first goods limit,
wherein each customer is taxed at the second tax rate for goods purchases beyond the first goods limit.

6. (canceled)

7. The method of operating the variable taxation system of claim 5, further comprising
identifying and linking in the customer database customer identification devices for each customer in the customer database.

8. (canceled)

9. The method of operating the variable taxation system of claim 5, further comprising
permitting a remaining balance to be transferred from one customer to another customer according to predetermined conditions.

10. The method of operating the variable taxation system of claim 5, further comprising
rolling over the remaining balance for a customer into a new predetermined time period.

11. The method of operating the variable taxation system of claim 5, further comprising
rolling over the remaining balance for a customer, up to a predetermined limit, into a new predetermined time period.

12. The method of operating the variable taxation system of claim 5, further comprising
maintaining, in the tax rate database, a different tax rate for each different type of goods.

13. The method of operating the variable taxation system of claim 5, further comprising
maintaining, in the tax rate database, a plurality of different tax rates corresponding to predetermined characteristics of each of the plurality of customers.

14. The method of operating the variable taxation system of claim 13, wherein the predetermined characteristics of each of the plurality of customers include at least one of
a customer income level,
a commercial use status,
a personal use status,
a pleasure/recreation use status,
a handicapped use status, and
a charitable use status.

15. The method of operating the variable taxation system of claim 5, further comprising
applying a default tax rate for purchases made without a customer identification, wherein the default tax rate is higher than the first tax rate.

16. The method of operating the variable taxation system of claim 8, further comprising
applying a default tax rate for purchases made without a remaining goods balance, wherein the default tax rate is higher than the first tax rate.

17. The method of operating the variable taxation system of claim 5, further comprising
communicating, at the time of purchase, the customer identification and a desired goods; and
determining a correct tax rate based on the customer identification and the goods desired for purchase.

18. The method of operating the variable taxation system of claim 17, further comprising
encrypting all communications.
